(19) United States
(12) Patent Application Publication
(10) Pub. No.: US 2024/0150523 A1
(43) Pub. Date: May 9, 2024

(54) HIGH TEMPERATURE RESISTANT SEMI-AROMATIC COPOLYIMIDE, PREPARATION METHOD, COMPOSITIONS, AND MOLDED PRODUCT

(71) Applicants: Cathay Biotech Inc., Shanghai (CN); CIBT America Inc., Newark, DE (US)

(72) Inventors: Wutong FENG, Shanghai (CN); Yuanbo ZHAO, Shanghai (CN); Xiucai LIU, Shanghai (CN)

(73) Assignees: Cathay Biotech Inc., Shanghai (CN); CIBT AMERICA INC., Newark, DE (US)

(21) Appl. No.: 18/412,986

(22) Filed: Jan. 15, 2024

Related U.S. Application Data
(63) Continuation of application No. PCT/CN2022/074273, filed on Jan. 27, 2022.

(30) Foreign Application Priority Data
Jul. 15, 2021 (CN) 202110799801.9

(51) Int. Cl. C08G 69/26; C08G 69/28

(52) U.S. Cl. CPC C08G 69/265; C08G 69/28

(57) ABSTRACT

The present disclosure provides a semi-aromatic copolyamide, its preparation method, compositions, and a molded product thereof. The semi-aromatic copolyamide is formed from raw materials including diacid monomers and diamine monomers. The diacid monomers include aromatic diacid or derivatives of the aromatic diacid and aliphatic diacid. The diamine monomers include decamethylene diamine and pentamethylene diamine. The molar ratio of the decamethylene diamine to the pentamethylene diamine is in a range of 1:1 to 30:1.

### CROSS-REFERENCE TO RELATED APPLICATIONS

This application is a continuation of International Application No. PCT/CN2022/074273, filed on Jan. 27, 2022, which claims priority to Chinese Patent Application No. 202110799801.9, filed on Jul. 15, 2021. The entire contents of each of the above-referenced applications are expressly incorporated herein by reference.

### TECHNICAL FIELD

The present disclosure relates to the field of polymer materials, and specially involves a high temperature resistant semi-aromatic copolyamide and its preparation method and compositions.

### BACKGROUND

With the rise of surface mounting technology (SMT) and the development trend of “plastic instead of steel” in the automotive industry, the market demand for high-temperature resistant polyamides has increased sharply. SMT technology requires that the melting point of the material is not less than 215° C., and lead-free solder puts higher requirements for the heat resistance of the material. The increase in combustion temperature of automobile fuel is conducive to the full combustion of fuel, reduction of fuel consumption, and decrease in carbon dioxide and other toxic gas emissions, and the increase in combustion temperature of fuel requires the peripheral parts of the automobile engine to have higher heat resistance. Traditional general-purpose plastics and ordinary engineering plastics have been unable to meet the market demand for heat resistance of materials. The melting point of high-temperature resistant polyamide is higher than 270° C., and it has excellent short-term and long-term heat resistance. The common high-temperature resistant polyamides are PA46, PAST, PA6T, PA9T, PA10T, PA11T, PA12T, PA MXD6, PMIA, PPTA and so on. PA10T, its full name is poly (decamethylene terephthalamide). The benzene rings structure of terephthalic acid makes it have high rigidity, heat resistance, mechanical strength and dimensional stability. And the long carbon chain structure of 1, 10-decamethylene diamine makes PA10T have such advantages as melt-processability and low water absorption. In addition, 1, 10-decamethylene diamine can be obtained from castor oil (biological substance) by saponification, ammonification and other steps, so PA10T is a promising bio-based high-temperature resistant polyamide. Similar to other semi-aromatic high temperature resistant polyamides, PA10T also has some disadvantages, such as poor melt fluidity and narrow melt processing window, so other copolymers are often introduced to improve the melt fluidity and reduce the melting point.

The patent CN101759853B provides a method for preparation of a semi-aromatic polyamide: firstly, the monomer and the auxiliary agent are added into the polymerization pot for condensation polymerization to get a prepolymer with low characteristic viscosity, and then the prepolymer is dried and transferred to a viscosifier for solid-phase polycondensation. However, this method will use a variety of equipment and its operation is complex.

### SUMMARY

In order to overcome the shortcomings of the existing technologies and products, the present disclosure provides a high temperature resistant semi-aromatic copolyamide and its preparation method, composition and molded product.

The monomer of the copolyamide comprises diacid monomers and diamine monomers, the diacid monomers comprise aromatic diacid and/or the derivatives of the aromatic diacid and aliphatic diacid, the diamine monomers comprise decamethylene diamine and pentamethylene diamine, the molar ratio of the decamethylene diamine to the pentamethylene diamine is (1-30):1.

Derivatives of aromatic diacid include but are not limited to amides of aromatic diacid and esters of aromatic diacid, such as C1-C10 alkyl esters of aromatic diacid.

1,10-decamethylene diamine (referred to as decamethylene diamine) in the monomer is chemically-derived or biological substance-derived 1, 10-decamethylene diamine, and biological substance-derived 1,10-decamethylene diamine is preferred. 1, 5-pentamethylene diamine (referred to as pentamethylene diamine) in the monomer is chemically-derived or biological substance-derived pentamethylene diamine, and biological substance-derived pentamethylene diamine is preferred. Biological substances are a variety of organisms formed by photosynthesis. Biological substance-derived compound refers to the compound prepared using these organisms through biological methods (e.g. biological fermentation). Chemically-derived compound refers to the compound prepared by chemical methods.

In some embodiments of the present disclosure, the molar ratio of the decamethylene diamine to the aromatic diacid is 1:(0.7-1.5), and preferably 1:(0.8-1.2); for example, 1:0.98, 1:0.95.

In some embodiments of the present disclosure, the molar ratio of the decamethylene diamine to the pentamethylene diamine is (2-30):1, and preferably (2-20):1; for example, 19:1, 18:1, 10:1, 6.5:1, 4:1.

In some embodiments of the present disclosure, the molar ratio of the diamine monomer to the diacid monomer is (1-1.3):1, and preferably (1-1.1): 1; and more preferably (1-1.06):1, and further more preferably (1.01-1.04):1.

In some embodiments of the present disclosure, the total amount of the diamine monomer and the diacid monomer accounts for 85% and more of the total amount of the monomer raw materials of the copolyamide, preferably 90% or more, more preferably 95% or more, and further more preferably 97% or more, the percentage refers to a molar percentage.

In some embodiments of the present disclosure, the total amount of the decamethylene diamine and the pentamethylene diamine accounts for 85% or more of the total amount of the diamine monomer, preferably 90% or more, and more preferably 95% or more, and the percentage is a molar percentage.

In some embodiments of the present disclosure, the total amount of the aromatic diacid and/or the derivatives of the aromatic diacid, and the aliphatic diacid accounts for 85% or more of the total amount of the diacid monomer, preferably 90% or more, and more preferably 95% or more, the percentage refers to molar percentage.

In some embodiments of the present disclosure, the aromatic diacid is any one of the diacids containing benzene rings with 8 or more carbon atoms, or a combination of 2 or more thereof, and preferably comprising any one of terephthalic acid, isophthalic acid and phthalic acid, or a combination of 2 or more thereof. The derivatives of the aromatic diacid comprise but are not limited to any one of benzoyl chloride, dimethyl terephthalate and diethyl terephthalate, or a combination of 2 or more thereof.

The aliphatic diacid is any one of: an aliphatic diacid with 2-18 carbon atoms and a combination thereof, and preferably comprising any one of oxalic acid, malonic acid, succinic acid, glutaric acid, adipic acid, heptanedioic acid, octanedioic acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, octadecanedioic acid, or a combination of 2 or more thereof.

In some embodiments of the present disclosure, the copolyamide is PA10T/5T/5X/10X. The X represents a structure unit derived from the aliphatic diacid, especially the number of carbon atoms contained in the aliphatic diacid. The aliphatic diacid has the same qualification as described above. T represents terephthalic acid. For example, copolyamide PA10T/5T/56/106 represents the copolyamide prepared by decamethylene diamine, terephthalic acid, pentamethylene diamine and adipic acid.

In some embodiments of the present disclosure, the raw materials of the copolyamide also comprise additives accounting for 0.01%-3% of the total mass of the monomers. The additives include but are not limited to any one of end-capping agent, catalyst, flame retardant, antioxidant, UV absorbent, infrared absorbent, crystallization nucleating agent, fluorescent brightening agent and antistatic agent, or a combination of 2 or more thereof.

In some embodiments of the present disclosure, the raw materials of the copolyamide also comprise antioxidants accounting for 0.1%-0.5% of total mass of the monomer, and preferably 0.1%-0.3%. The antioxidants are selected from any one of phenolic antioxidant, inorganic phosphate antioxidant, phosphite ester antioxidant and carbon free radical trapping antioxidant, or a combination of 2 or more thereof.

In some embodiments of the present disclosure, the raw materials of the copolyamide also comprise catalysts accounting for 0-0.07% of total mass of the monomer, and preferably 0.005-0.05%. The catalysts comprise phosphate and hypophosphite, and preferably comprise phosphate of alkali metal and/or alkaline-earth metal, and hypophosphite of alkali metal and/or alkaline-earth metal, and more preferably comprise any one of potassium hypophosphite, sodium hypophosphite, calcium hypophosphite and magnesium hypophosphate, or a combination of 2 or more thereof. preferably, total mass of the phosphate and the hypophosphite accounts for 85% or more of total mass of catalyst, preferably 90% or more, and more preferably 95% or more.

In some embodiments of the present disclosure, the raw materials of the copolyamide also comprise end-capping agents accounting for 0-1% of total mass of the monomer, preferably 0.1-0.5%, and more preferably 0.15%-0.4%. The end-capping agents comprise any one of C2-C16 aliphatic carboxylic acid and C7-C10 aromatic carboxylic acid or a combination thereof. The structures of the end-capping agents of the aliphatic carboxylic acid are linear-chain monoacid, monoacid with branch chain or monoacid with cyclic structure, and preferably saturated linear-chain monoacid, saturated monoacid with branch chain, or saturated monoacid with cyclic structure. Compared with aliphatic carboxylic acid with liner-chain structure, saturated aliphatic carboxylic acid with cyclic structure has a better effect on reducing polymer YI value, which is mainly because the aliphatic carboxylic acid with cyclic structure has a larger steric hindrance effect, so that the coplanarity of the atomic group is destroyed, and the overlap degree of π electrons is reduced, and thus the absorption spectrum moves towards the short wave.

In some preferred embodiments of the present disclosure, the end-capping agent comprises any one of C2-C10 aliphatic carboxylic acid or C7-C10 aromatic carboxylic acid and a combination thereof. The number of carbon atoms of the end-capping agent is, for example, 3, 4, 5, 6, 7, 8, 9.

In some preferred embodiments of the present disclosure, the end-capping agent comprises any one of acetic acid, propionic acid, butyric acid, valeric acid, caproic acid, heptanoic acid, caprylic acid, pelargonic acid, capric acid, trimethylacetic acid, isobutyric acid, benzoic acid, cyclohexanecarboxylic acid, toluic acid, α-naphthoic acid, β-naphthoic acid, methylnaphthoic acid and phenylacetic acid, or a combination of 2 or more thereof.

In some preferred embodiments of the present disclosure, the total mass of the C2-C10 aliphatic carboxylic acid, C7-C10 aromatic carboxylic acid account for 85% or more of total mass of end-capping agent, preferably 90% or more, and more preferably 95% or more.

In some embodiments of the present disclosure, the melting point of the copolyamide is 270° C. or more, and preferably 270° C.-310° C., for example 280° C., 290° C., 300° C., 305° C.

The relative viscosity of the copolyamide is 1.6-3.2, and preferably 2.2-3.0, and more preferably 2.2-2.6, for example, 2.3, 2.4, 2.5.

The water absorption of the copolyamide is 0.1-1%, and preferably 0.2-0.8%, for example, 0.4%, 0.6% or 0.7%.

The tensile strength of the copolyamide is 50-140 MPa, and preferably 60-120 MPa, and more preferably 70-110 MPa, for example, 80 MPa, 90 MPa, 95 MPa, 100 MPa or 105 MPa.

In some embodiments of the present disclosure, the bending strength of the copolyamide is 70-130 MPa, preferably 85-130 MPa, and more preferably 90-130 MPa, for example 100 MPa, 105 MPa, 110 MPa, 115 MPa, 120 MPa, or 125 MPa.

In some embodiments of the present disclosure, the heat distortion temperature of the copolyamide is 95-130° C., and preferably 100-125° C., for example, 105° C., 110° C., 115° C. or 120° C.

In some embodiments of the present disclosure, the yellow color index YI value of the copolyamide is 15 or less, and preferably 13 or less, and more preferably 10 or less, and more preferably 7 or less, for example, 2-7, 6 or 5.

After a lot of research, the inventor found that amidogen is a kind of auxochrome, which can make the color of the polymer containing chromophore darker. Using catalyst can reduce the concentration of the amino end groups of the polymer, so as to increase the molecular weight of the polymer to obtain a polymer with better mechanical properties and lower YI value.

In addition, for semi-aromatic polyamides with long carbon chain structure, it is easy to occur such problems as high polymer viscosity and poor melt fluidity in polymerization. At present, increasing the temperature and accelerating the shearing rate are used as common methods to reduce the excessive polymer melt viscosity, but the temperature rise will promote the polymer to appear yellowing phenomena. Adding the end-capping agent can regulate the viscosity of the polymer melt, reduce the cross-linking of amino end groups at high temperature, increase the fluidity of the polymer melt, and decrease the YI value of the polymer.

In another aspect, this disclosure provides a method for preparing a high temperature resistant semi-aromatic copolyamide, comprising the steps of:
1) adding decamethylene diamine, pentamethylene diamine, aromatic diacid and/or derivatives of the aromatic diacid, and aliphatic diacid to water and heating to 70-90° C., and optionally, holding at 70-90° C. for 0.5-3 h, to obtain a mixture containing polyamide salts;
2) heating the mixture containing polyamide salts to 120-140° C. and concentrating the heated product by degassing, and then heating to 240-255° C. for reaction; and
3) reducing the pressure of the reaction system by degassing.

The person skilled in the art know that the salt formed by the reaction of diamine and diacid is known as polyamide salt (also known as nylon salt), and polyamide or copolyimide is synthesized through polycondensation of polyamide salt.

Unless otherwise stated or in apparent contradiction, the pressure mentioned in the present disclosure refers to gauge pressure.

In some embodiments of the present disclosure, in step 1) the heating process is carried out under inert gas atmosphere; the inert gas comprises one or more of nitrogen, argon or helium.

In some embodiments of the present disclosure, in step 1) the holding time is 0.5-2 h.

In some embodiments of the present disclosure, in step 2) the mixture is concentrated to produce a 40 wt. %-80 wt. % of polyamide salt solution, and preferably 55 wt. %-65 wt. % of polyamide salt solution.

In some embodiments of the present disclosure, in step 2) the reaction time is 0.5-2 h, and preferably 1-1.5 h.

In some embodiments of the present disclosure, in step 2) the pressure of the reaction system is maintained at 2.5-3 MPa.

In some embodiments of the present disclosure, in step 3) the pressure of the reaction system is reduced to 0-0.2 MPa (gauge pressure) through degassing.

In some embodiments of the present disclosure, in step 3) the temperature of the reaction system after pressure reduction is 315-335° C.

In some embodiments of the present disclosure, the method includes step 4): vacuumizing treatment: vacuumizing the reaction system to −0.02 MPa or less, and preferably −0.05 MPa to −0.1 MPa. The vacuuming treatment step before melting discharge can avoid a small number of small molecules such as water remaining in the reaction system when the pressure drops to 0 in the pressure relief stage, and these small molecules will degrade the polymer under high temperature environment, and thus affecting the performance of the material.

Optionally, holding the vacuum degree of the reaction system mentioned for 0-300 s, preferably 0-90 s, and more preferably 5-90 s.

In some embodiments of the present disclosure, if the vacuum degree holding time is within the above range, it is beneficial to keep product quality and ensure the copolyamide melt is strand pelletized, thus facilitating the follow-up processing.

In some embodiments of the present disclosure, the method also includes step 5): discharging, stretching into strips and pelletizing.

In some embodiments of the present disclosure, the method also comprises adding an additive at any stage of step 1), step 2), step 3) and step 4). The additive has the same limitation as above.

In some embodiments of the present disclosure, the method for preparing the high temperature resistant semi-aromatic copolyamide comprises:
1) adding decamethylene diamine, pentamethylene diamine, aromatic diacid and/or derivatives of the aromatic diacid, and aliphatic diacid to water and heating to 70-90° C., and holding at 70-90° C. for 0.5-3 h, to obtain a mixture containing polyamide salts;
2) heating the mixture containing polyamide salt is heated to 120-140° C., and concentrating the heated product to 40 wt. %-80 wt. % of the concentration of the polyamide salt by degassing, and then heating to 240-255° C. to react for 0.5-2 h at 2.5-3 MPa.
3) reducing the pressure of reaction system to 0-0.2 MPa (gauge pressure) by degassing, and after that the temperature of the reaction system is 315-335° C.;
4) vacuumizing the reaction system to −0.05 MPa to −0.1 MPa, and the holding the vacuum degree for 0-300 s;
5) discharging, stretching into strips and pelletizing.

The parameters for the method have the further limitations mentioned above.

In another aspect, the present disclosure provides a composition, the composition comprises any one of the high temperature resistant semi-aromatic copolyamide mentioned above.

In another aspect, the present disclosure provides a product prepared by using the high temperature resistant semi-aromatic copolyamide mentioned above as a raw material.

In order to obtain the product of the present disclosure, the copolyamide in the present disclosure can be molded by any molding methods such as injection, extrusion, blowing, vacuuming, melt spinning and film forming. The products can be molded into desired shape and used as resin molded products for automotive parts and mechanical parts.

Compared with the existing technologies, the present disclosure has at least the following advantages:
1. the copolyamide of the present disclosure has the same comprehensive performance as the existing polyamide, and can use the monomer pentamethylene diamine developed by independent intellectual property rights, so as to avoid using the monomer hexanediamine monopolized by foreign companies.
2. the copolyamide of the present disclosure has excellent mechanical properties, its tensile properties, bending resistance and impact resistance can be comparable with polyamide PA6, polyamide PA66 and other polyamide products used in the market.
3. the copolyamide of the present disclosure has a lower water absorption and a better dimensional stability, a higher heat distortion temperature and a lower yellow color index, and can be used in a more rigorous environment, thus expanding the use range of the polyamide to a certain extent.
4. the preparation method of the copolyamide of the present disclosure is simple and has such advantages as easy to control the process parameters, no need for large instruments, and convenient for mass production.

### DETAILED DESCRIPTION

In order to make the purpose, technical proposal and advantages of the present disclosure clearer, the following paragraph will describe the technical proposal in the disclosure examples. Obviously, the examples described are only part of examples of the present disclosure rather than all of the examples. Based on the examples in the present disclosure, all other examples obtained by ordinary persons skilled in the art without creative work belong to the scope of protection of the disclosure.

1. Detection Method of Relative Viscosity ηr

The relative viscosity is measured by the concentrated sulfuric acid method using the Ubbelohde viscometer, which comprises the steps of: 0.5±0.0002 g of dried polyamide sample is accurately weighed, and dissolved by adding 50 mL of concentrated sulfuric acid (98%), the flow time of the concentrated sulfuric acid t0 and the flow time of the polyamide solution t in a water bath at a constant temperature of 25° C. are measured and recorded.

The formula for calculating relative viscosity is as follows:

Relative viscosity ηr=t/t0

wherein t is the flow time of the polyamide solution; t0 is the flow time of the concentrated sulfuric acid solvent.

2. Test method of mechanical properties
Bending strength test according to ISO-178, test condition: 2 mm/min;
Tensile strength test according to ISO-572-2, test conditions: 50 mm/min;
3. Water absorption test: ISO-62:2008;
4. Heat distortion temperature test: ASTM D648;
5. Yellow color index test

The yellow color index is the yellow color value that uses the C light source of the International Commission on Illumination (CIE) and takes magnesium oxide as reference. The yellow color index YI is calculated as follows:

YI=(100(1.28X−1.06Z))/Y, wherein X, Y and Z are the measured tristimulus values respectively. The yellow index instrument is used to detect at the temperature of 25±5° C. and relative humidity of 50±20%.

### Example 1

9.45 mol of 1,10-decamethylene diamine, 9.36 mol of terephthalic acid, 0.54 mol of 1,5-pentamethylene diamine, 0.53 mol of adipic acid, 9.9 g of antioxidant H10 (purchased from BRUGGOLEN, Germany), 7.83 g of acetic acid (end-capping agent), 0.66 g of sodium hypophosphite (catalyst) were mixed with water evenly, and the thus obtained system was heated to 90° C. under a nitrogen atmosphere and was maintained 1 h at the temperature to obtain a mixture containing polyamide salt (i.e., nylon salt) with a mass concentration of 50 wt. %;

the reaction system was heated to 130° C. and the mass concentration of nylon salt was concentrated to 65 wt. % by degassing. Then, the reaction system was further heated to 250° C. and the pressure of the reaction system was maintained at 2.5 MPa for 1 h for reaction. The pressure of the reaction system was reduced to 0 MPa (gauge pressure) by degassing, and the temperature of the reaction system was 335° C. after the pressure reduction. And then the reaction system was vacuumized to −0.07 MPa, the copolyamide melt was obtained. After discharging, the copolyamide melt was stretched into strips and pelletized to obtain a high temperature resistant semi-aromatic copolyamide PA10T/5T/56/106.

### Example 2

9.09 mol of 1,10-decamethylene diamine, 9 mol of terephthalic acid, 1.01 mol of 1, 5-pentamethylene diamine, 1 mol of adipic acid, 9.9 g of antioxidant H10, 7.83 g of benzoic acid (end-capping agent), 0.66 g of sodium hypophosphite (catalyst) were mixed with water evenly, and the thus obtained system was heated to 90° C. under a nitrogen atmosphere and maintained 1 h at the temperature to obtain a mixture containing polyamide salt with a mass concentration of 50 wt. %;

the reaction system was heated to 130° C. and the mass concentration of nylon salt was concentrated to 65 wt. % by degassing. Then, the system was further heated to 250° C. and the pressure of the reaction system was maintained at 2.5 MPa for 1 h for reaction. The pressure of the reaction system was reduced to 0 MPa (gauge pressure) by degassing, and the temperature of the reaction system was 325° C. after the pressure reduction. And then the reaction system was vacuumized to −0.07 MPa and was maintained 30 s to obtain the copolyamide melt. After discharging, the copolyamide melt was stretched into strips and pelletized to obtain a high temperature resistant semi-aromatic copolyamide PA10T/5T/56/106.

### Example 3

8.585 mol of 1,10-decamethylene diamine, 8.5 mol of terephthalic acid, 1.5 mol of 1,5-pentamethylene diamine, 1.5 mol of adipic acid, 9.8 g of antioxidant H10, 0.65 g of sodium hypophosphite (catalyst), 7.83 g of acetic acid (end-capping agent) were mixed with water evenly, and the thus obtained system was heated to 90° C. under a nitrogen atmosphere and was maintained 1 h at the temperature to obtain a mixture containing polyamide salt with a mass concentration of 50 wt. %;

the reaction system was heated to 130° C. and the mass concentration of nylon salt was concentrated to 65 wt. % by degassing. Then, the system was further heated to 250° C. and the pressure of the reaction system was maintained at 2.5 MPa for 1 h for reaction. The pressure of the reaction system was reduced to 0 MPa (gauge pressure) by degassing, and the temperature of the reaction system was 325° C. after the pressure reduction. And then the reaction system was vacuumized to −0.07 MPa and was maintained 30 s to obtain the copolyamide melt. After discharging, the copolyamide melt was stretched into strips and pelletized to obtain a high temperature resistant semi-aromatic copolyamide PA10T/5T/56/106.

### Example 4

8.08 mol of 1,10-decamethylene diamine, 8 mol of terephthalic acid, 2.02 mol of 1,5-pentamethylene diamine, 2 mol of adipic acid, 9.8 g of antioxidant H10, 0.66 g of calcium hypophosphite (catalyst), 7.8 g of cyclohexanecarboxylic acid (end-capping agent) were mixed with water evenly, and the thus obtained system was heated to 90° C. under a nitrogen atmosphere and was maintained 1 h at the temperature to obtain a mixture containing polyamide salt with a mass concentration of 50 wt. %;

the reaction system was heated to 130° C. and the mass concentration of nylon salt was concentrated to 65 wt. % by degassing Then, the system was further heated to 250° C. and the pressure of the reaction system was maintained at 2.5 MPa for 1 h for reaction. The pressure of the reaction system was reduced to 0 MPa (gauge pressure) by degassing, and the temperature of the reaction system was 325° C. after the pressure reduction. And then the reaction system was vacuumized to −0.07 MPa and was maintained 70 s to obtain the copolyamide melt. After discharging, the copolyamide melt was stretched into strips and pelletized to obtain a high temperature resistant semi-aromatic copolyamide PA10T/5T/56/106.

### Example 5

It was basically the same as example 3, and the only difference between the example 5 and the example 3 was that the raw materials of the copolyamide PA10T/5T/56/106 of this example 5 did not contain catalyst.

### Example 6

It was basically the same as example 3, and the only difference between the example 6 and the example 3 was that the raw materials of the copolyamide PA10T/5T/56/106 of this example 5 did not contain end-capping agent.

### Example 7

8.08 mol of 1,10-decamethylene diamine, 8 mol of terephthalic acid, 2.02 mol of 1,5-pentamethylene diamine, 2 mol of dodecanedioic acid, 10.0 g of antioxidant H10, 0.70 g of sodium hypophosphite (catalyst), 8.3 g of cyclohexanecarboxylic acid (end-capping agent) were mixed with water evenly, and the thus obtained system was heated to 90° C. under a nitrogen atmosphere and was maintained 1 h at the temperature to obtain a mixture containing polyamide salt with a mass concentration of 50 wt. %;

the reaction system was heated to 130° C. and the mass concentration of nylon salt was concentrated to 65 wt. % by degassing. Then, the reaction system was further heated to 250° C. and the pressure of the reaction system was maintained at 2.5 MPa for 1 h for reaction. The pressure of the reaction system was reduced to 0 MPa (gauge pressure) by degassing, and the temperature of the reaction system was 325° C. after the pressure reduction. And then the reaction system was vacuumized to −0.07 MPa and was maintained 60 s to obtain the copolyamide melt. After discharging, the copolyamide melt was stretched into strips and pelletized to obtain a high temperature resistant semi-aromatic copolyamide PA10T/5T/512/1012.

### Example 8

8.585 mol of 1,10-decamethylene diamine, 8.5 mol of terephthalic acid, 1.5 mol of 1,5-pentamethylene diamine, 1.5 mol of hexadecanedioic acid, 10.2 g of antioxidant H10, 0.72 g of calcium hypophosphite (catalyst), 8.2 g of acetic acid (end-capping agent) were mixed with water evenly, and the thus obtained system was heated to 90° C. under a nitrogen atmosphere and was maintained at the temperature for 1 h to obtain a mixture containing polyamide salt with a mass concentration of 50 wt. %;

the reaction system was heated to 130° C. and the mass concentration of nylon salt was concentrated to 65 wt. % by degassing. Then, the reaction system was further heated to 250° C. and the pressure of the reaction system was maintained at 2.5 MPa for 1 h for reaction. The pressure of the reaction system was reduced to 0 MPa (gauge pressure) by degassing, and the temperature of the reaction system was 325° C. after the pressure reduction. And then the reaction system was vacuumized to −0.07 MPa and was maintained 30 s to obtain the copolyamide melt. After discharging, the copolyamide melt was stretched into strips and pelletized to obtain a high temperature resistant semi-aromatic copolyamide PA10T/5T/516/1016.

### Example 9

8.585 mol of 1,10-decamethylene diamine, 8.5 mol of terephthalic acid, 1.5 mol of 1,5-pentamethylene diamine, 1.5 mol of adipic acid, 9.8 g of antioxidant H10, 0.65 g of sodium hypophosphite (catalyst), 7.83 g of acetic acid (end-capping agent) were mixed with water evenly, and the thus obtained system was heated to 90° C. under a nitrogen atmosphere and was maintained 1 h at the temperature to obtain a mixture containing polyamide salt with a mass concentration of 50 wt. %;

the reaction system was heated to 130° C. and the mass concentration of nylon salt was concentrated to 65 wt. % by degassing. Then, the reaction system was further heated to 250° C. and the pressure of the reaction system was maintained at 2.5 MPa for 1 h for reaction. The pressure of the reaction system was reduced to 0 MPa (gauge pressure) by degassing, and the temperature of the reaction system was 325° C. after the pressure reduction, the copolyamide melt was obtained. After discharging, the copolyamide melt was stretched into strips and pelletized to obtain a high temperature resistant semi-aromatic copolyamide PA10T/5T/56/106.

Comparison 1

(1) Pre-polymerization: 8.585 mol of 1,10-decamethylene diamine, 8.5 mol of terephthalic acid, 1.5 mol of 1,5-pentenediamine, 1.5 mol of adipic acid, 9.8 g of antioxidant, 0.65 g of sodium hypophosphite (catalyst), 7.83 g of acetic acid (end-capping agent) were mixed with water evenly, and the thus obtained system was heated to 90° C. under nitrogen atmosphere and was maintained 1 h to get a mixture containing polyamide salt with a mass concentration of 50 wt. %. The reaction system was heated to 130° C. and concentrated to 65 wt. % of the mass concentration of the nylon salt by degassing; and then the system was further heated to 250° C. and the pressure of the reaction system was maintained at 2.5 MPa for 1 h for reaction. Then, the pressure of the reaction system was reduced to 0 MPa (gauge pressure) by degassing and at the same time the temperature of the reaction system was maintained at 273° C., and the pressure of the reaction system was vacuumized to −0.07 MPa and was maintained 30 s. And a solid prepolymer was obtained after the reaction system was cooled to room temperature.

(2) Solid-phase polycondensation: the prepolymer was crushed into solid particles with a size of about 0.1 mm, and put into the vacuum drum for thickening at 250° C. for 8 h, with a vacuum degree of 20-50 Pa, and then was cooled to room temperature to obtain the copolyamide PA10T/5T/56/106.

The copolyamide prepared in example 1 to 9 and comparison 1 was subject to such tests as relative viscosity, tensile strength, bending strength, water absorption, thermal distortion temperature, melting point and yellow color index YI value. The test results were shown in Table 1.

TABLE 1

| | | | Heat | | | | |
|---|---|---|---|---|---|---|---|
| | | Water | distortion | Melting | Tensile | Bending | |
| | Relative | absorption | temperature | point | strength | strength | YI |
| Example | viscosity | % | 0° C. | 0° C. | MPa | MPa | value |
| Example 1 | 2.18 | 0.33 | 118 | 312 | 89 | 110 | 5.9 |
| Example 2 | 2.60 | 0.48 | 111 | 298 | 86 | 108 | 6.2 |
| Example 3 | 2.36 | 0.61 | 102 | 290 | 81 | 105 | 5.6 |
| Example 4 | 2.33 | 0.78 | 96 | 281 | 78 | 100 | 5.0 |
| Example 5 | 1.75 | 0.65 | 94 | 289 | 65 | 98 | 10.2 |
| Example 6 | 2.54 | 0.57 | 102 | 290 | 85 | 108 | 12.2 |
| Example 7 | 2.36 | 0.63 | 94 | 278 | 76 | 98 | 5.5 |
| Example 8 | 2.38 | 0.31 | 100 | 287 | 79 | 102 | 6.0 |
| Example 9 | 1.73 | 0.63 | 102 | 290 | 70 | 83 | 13.4 |
| Comparison 1 | 2.01 | 0.70 | 102 | 289 | 74 | 98 | 24.8 |

As can be seen from Table 1, all examples adopted one-step method to prepare copolyamide PA10T/5T/5X/10X, which is easy to operate. Comparison 1 used a two-step method that the copolyamide was prepared by prepolymerization and then solid phase polycondensation, which had such disadvantages as low equipment utilization efficiency and complicated operation. By comparing example 3 with comparison 1, it can be seen that solid-phase polycondensation has a very limited effect on increase in the viscosity of prepolymerization, and YI value of the sample was much higher than that of the sample prepared by one-step method, which may be caused by uneven heating of the sample in the solid phase polycondensation equipment. If the sample yellowed, that indicates that the samples were aged and degraded. As a result, it led to reduction of their mechanical properties.

Finally, it should be noted that the above examples are intended only to explain the technical solutions of the present disclosure, rather than limiting thereto. Although the present disclosure has been described in detail with reference to the forgoing examples, those skilled in the art should understand that modifications can still be made to the technical solutions set forth in the preceding examples, or equivalent substitutions can be made to part or all of the technical features thereof, and these modifications or substitutions do not make the essence of the corresponding technical solutions depart from the scope of the technical solutions in the examples of the present disclosure.

What is claimed is:

1. A semi-aromatic copolyamide formed from raw materials comprising diacid monomers and diamine monomers, wherein:
the diacid monomers comprise aromatic diacid or derivatives of the aromatic diacid and aliphatic diacid; and
the diamine monomers comprise decamethylene diamine and pentamethylene diamine, and a molar ratio of the decamethylene diamine to the pentamethylene diamine is in a range of 1:1 to 30:1.

2. The semi-aromatic copolyamide according to claim 1, wherein:
the decamethylene diamine is chemically derived or biological substance-derived 1,10-decamethylene diamine;
the pentamethylene diamine is chemically derived or biological substance-derived 1,5-pentamethylene diamine;
a molar ratio of the decamethylene diamine to the aromatic diacid is in a range of 1:0.7 to 1:1.5;
a molar ratio of the decamethylene diamine to the pentamethylene diamine is in a range of 2:1 to 30:1;
a molar ratio of the pentamethylene diamine to the aliphatic diacid is in a range of 1:1 to 1.3:1;
a molar ratio of the diamine monomer to the diacid monomer is in a range of 1:1 to 1.3:1;
a total amount of the diamine monomer and the diacid monomer accounts for 85 mol % or more of a total amount of the raw materials of the copolyamide;
a total amount of the decamethylene diamine and the pentamethylene diamine accounts for 85 mol % or more of the total amount of the diamine monomer; or
a total amount of the aromatic diacid or the derivatives of the aromatic diacid and the aliphatic diacid accounts for 85 mol % or more of the total amount of the diacid monomer.

3. The semi-aromatic copolyamide according to claim 1, wherein:
a molar ratio of the decamethylene diamine to the aromatic diacid is in a range of 1:0.8 to 1:1.2;
a molar ratio of the decamethylene diamine to the pentamethylene diamine is in a range of 2:1 to 20:1;
a molar ratio of the pentamethylene diamine to the aliphatic diacid is in a range of 1:1 to 1.06:1;
a molar ratio of the diamine monomer to the diacid monomer is in a range of 1:1 to 1.06:1;
a total amount of the diamine monomer and the diacid monomer accounts for 95 mol % or more of a total amount of the raw materials of the copolyamide;
a total amount of the decamethylene diamine and the pentamethylene diamine accounts for 95 mol % or more of the total amount of the diamine monomer; or
a total amount of the aromatic diacid or the derivatives of the aromatic diacid and the aliphatic diacid accounts for 95 mol % or more of the total amount of the diacid monomer.

4. The semi-aromatic copolyamide according to claim 1, wherein:
the aromatic diacid is any one of: diacids containing benzene rings with 8 or more carbon atoms, or a combination of 2 or more diacids containing benzene rings with 8 or more carbon atoms;
the derivative of the aromatic diacid comprises any one of paraphthaloyl chloride, dimethyl terephthalate, or diethyl terephthalate, or a combination of 2 or more thereof; or
the aliphatic diacid is any one of: an aliphatic diacid with 2-18 carbon atoms or a combination of aliphatic diacids with 2-18 carbon atoms.

5. The semi-aromatic copolyamide according to claim 1, wherein:
the aromatic diacid comprises any one of terephthalic acid, isophthalic acid and phthalic acid, or a combination of 2 or more thereof; or
the aliphatic diacid comprises any one of oxalic acid, malonic acid, succinic acid, glutaric acid, adipic acid, heptanedioic acid, octanedioic acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, octadecanedioic acid, or a combination of 2 or more thereof.

6. The semi-aromatic copolyamide according to claim 1, wherein the raw materials of the semi-aromatic copolyamide comprise:
additives accounting for 0.01%-0.03% of a total mass of all monomers, the additives comprise any one of an end-capping agent, a catalyst, a flame retardant, an antioxidant, a UV absorbent, an infrared absorbent, a crystallization nucleating agent, a fluorescent brightening agent, or an antistatic agent, or a combination of 2 or more thereof;
antioxidants accounting for 0.1%-0.5% of the total mass of the monomers, the antioxidants comprise any one of a phenolic antioxidant, an inorganic phosphate antioxidant, a phosphite ester antioxidant, a carbon free radical trapping antioxidant, or a combination of 2 or more thereof;
catalysts accounting for 0-0.07% of the total mass of the monomers, wherein the catalysts comprise a phosphate and a hypophosphite; or
end-capping agents accounting for 0-1% of the total mass of the monomers, wherein the end-capping agents comprise any one of a C2-C16 aliphatic carboxylic acid or a C7-C10 aromatic carboxylic acid or a combination thereof, including any one of acetic acid, propionic acid, butyric acid, valeric acid, caproic acid, heptanoic acid, caprylic acid, pelargonic acid, capric acid, trimethylacetic acid, isobutyric acid, benzoic acid, cyclohexanecarboxylic acid, toluic acid, α-naphthoic acid, β-naphthoic acid, methylnaphthoic acid, or phenylacetic acid, or a combination of 2 or more thereof.

7. The semi-aromatic copolyamide according to claim 6, wherein:
the catalysts comprise a phosphate of alkali metal, a phosphate of alkaline-earth metal, a hypophosphite of alkali metal, or a hypophosphite of alkaline-earth metal; or
the end-capping agents comprise any one of C2-C10 aliphatic carboxylic acid or C7-C10 aromatic carboxylic acid or a combination thereof.

8. The semi-aromatic copolyamide according to claim 6, wherein:
the catalysts comprise any one of potassium hypophosphite, sodium hypophosphite, calcium hypophosphite and magnesium hypophosphate, or a combination of 2 or more thereof; or
the end-capping agents comprise any one of acetic acid, propionic acid, butyric acid, valeric acid, caproic acid, heptanoic acid, caprylic acid, pelargonic acid, capric acid, trimethylacetic acid, isobutyric acid, benzoic acid, cyclohexanecarboxylic acid, toluic acid, α-naphthoic acid, β-naphthoic acid, methylnaphthoic acid, or phenylacetic acid, or a combination of 2 or more thereof.

9. The semi-aromatic copolyamide according to claim 1, wherein:
a melting point of the semi-aromatic copolyamide is 270° C. or higher;
a heat distortion temperature of the semi-aromatic copolyamide is 95-130° C.;
water absorption of the semi-aromatic copolyamide is 0.1-1%;
relative viscosity of the semi-aromatic copolyamide is 1.0-3.2;
tensile strength of the semi-aromatic copolyamide is 50-140 MPa;
bending strength of the semi-aromatic copolyamide is 70-130 MPa; or
a yellow color index (YI) value of the semi-aromatic copolyamide is 15 or less.

10. A method for preparing semi-aromatic copolyamide, comprising steps:
1) adding decamethylene diamine, pentamethylene diamine, aromatic diacid or derivatives of the aromatic diacid, and aliphatic diacid to water, heating to 70-90° C., and maintaining at 70-90° C. for 0.5-3 h to obtain a mixture containing polyamide salts;
2) heating the mixture containing polyamide salts to 120-140° C. and concentrating the heated product by degassing, then heating the product to 240-255° C. for reaction; and
3) reducing pressure of reaction system by degassing.

11. The method according to claim 10, wherein:
in step 1), the heating is carried out under inert gas atmosphere;
in step 1), the maintaining is for 0.5-2 h;
in step 2), concentrating the heated product is to produce a 40 wt. %-80 wt. % of polyamide salt solution;
in step 2), reaction time is 0.5-2 h;
in step 2), the pressure of the reaction system is maintained at 2.5-3 MPa;
in step 3), the pressure of the reaction system is reduced to 0-0.2 MPa (gauge pressure) through degassing;
in step 3), temperature of the reaction system after pressure reduction is 315-335° C.; or
the method further comprises step 4): vacuumizing treatment including vacuumizing the reaction system to −0.02 MPa or less, maintaining the vacuum degree of the reaction system for 0-300 s.

12. The method according to claim 11, wherein:
the method further comprises step 5): discharging products, stretching the products into strips, and pelletizing the products.

13. The method according to claim 11, further comprising adding an additive in any step 1), 2), 3), and 4), wherein the additive accounts for 0.01%-3% of total mass of monomers, the additive comprises any one of an end-capping agent, a catalyst, a flame retardant, an antioxidant, a UV absorbent, an infrared absorbent, a crystallization nucleating agent, a fluorescent brightening agent, or an antistatic agent, or a combination of 2 or more thereof.

14. The method according to claim 11, wherein in step 4, the vacuum degree of the reaction system is maintained for 0-90 s.

15. The method according to claim 11, wherein in step 4, the vacuum degree of the reaction system is maintained for 5-90 s.

16. A composition, comprising a semi-aromatic copolyamide, wherein the semi-aromatic copolyamide is formed from raw materials comprising diacid monomers and diamine monomers, wherein:
the diacid monomers comprise aromatic diacid or derivatives of the aromatic diacid and aliphatic diacid; and
the diamine monomers comprise decamethylene diamine and pentamethylene diamine, and a molar ratio of the decamethylene diamine to the pentamethylene diamine is in a range of 1:1 to 30:1.

17. The composition according to claim 16, wherein:
the decamethylene diamine is chemically derived or biological substance-derived 1,10-decamethylene diamine;
the pentamethylene diamine is chemically derived or biological substance-derived 1,5-pentamethylene diamine;
a molar ratio of the decamethylene diamine to the aromatic diacid is in a range of 1:0.7 to 1:1.5;
a molar ratio of the decamethylene diamine to the pentamethylene diamine is in a range of 2:1 to 30:1;
a molar ratio of the pentamethylene diamine to the aliphatic diacid is in a range of 1:1 to 1.3:1;
a molar ratio of the diamine monomer to the diacid monomer is in a range of 1: to 1.3:1;
a total amount of the diamine monomer and the diacid monomer accounts for 85 mol % or more of a total amount of the raw materials of the copolyamide;
a total amount of the decamethylene diamine and the pentamethylene diamine accounts for 85 mol % or more of the total amount of the diamine monomer; or
a total amount of the aromatic diacid or the derivatives of the aromatic diacid and the aliphatic diacid accounts for 85 mol % or more of the total amount of the diacid monomer.

18. The composition according to claim 16, wherein:
the aromatic diacid is any diacids containing benzene rings with 8 or more carbon atoms, or a combination of 2 or more diacids containing benzene rings with 8 or more carbon atoms;
the derivative of the aromatic diacid comprises any one of paraphthaloyl chloride, dimethyl terephthalate, or diethyl terephthalate, or a combination of 2 or more thereof; or
the aliphatic diacid is any aliphatic diacid with 2-18 carbon atoms or a combination of aliphatic diacids with 2-18 carbon atoms.

19. The composition according to claim 16, wherein the raw materials of the semi-aromatic copolyamide comprise:
additives accounting for 0.01%-0.03% of a total mass of all monomers, the additives comprise any one of an end-capping agent, a catalyst, a flame retardant, an antioxidant, a UV absorbent, an infrared absorbent, a crystallization nucleating agent, a fluorescent brightening agent, or an antistatic agent, or a combination of 2 or more thereof;
antioxidants accounting for 0.1%-0.5% of the total mass of the monomers, the antioxidants comprise any one of a phenolic antioxidant, an inorganic phosphate antioxidant, a phosphite ester antioxidant, a carbon free radical trapping antioxidant, or a combination of 2 or more thereof;
catalysts accounting for 0-0.07% of the total mass of the monomers, wherein the catalysts comprise a phosphate and a hypophosphite; or
end-capping agents accounting for 0-1% of the total mass of the monomers, wherein the end-capping agents comprise any one of a C2-C16 aliphatic carboxylic acid or a C7-C10 aromatic carboxylic acid or a combination thereof, including any one of acetic acid, propionic acid, butyric acid, valeric acid, caproic acid, heptanoic acid, caprylic acid, pelargonic acid, capric acid, trimethylacetic acid, isobutyric acid, benzoic acid, cyclohexanecarboxylic acid, toluic acid, α-naphthoic acid, β-naphthoic acid, methylnaphthoic acid, or phenylacetic acid, or a combination of 2 or more thereof.

20. The composition according to claim 16, wherein:
a melting point of the semi-aromatic copolyamide is 270° C. or higher;
a heat distortion temperature of the semi-aromatic copolyamide is 95-130° C.;
water absorption of the semi-aromatic copolyamide is 0.1-1%;
relative viscosity of the semi-aromatic copolyamide is 1.0-3.2;
tensile strength of the semi-aromatic copolyamide is 50-140 MPa;
bending strength of the semi-aromatic copolyamide is 70-130 MPa; or
yellow color index (YI) value of the semi-aromatic copolyamide is 15 or less.

21. A product prepared by using a semi-aromatic copolyamide as a raw material, wherein the semi-aromatic copolyamide is formed from raw materials comprising diacid monomers and diamine monomers, wherein:
the diacid monomers comprise aromatic diacid or derivatives of the aromatic diacid and aliphatic diacid; and
the diamine monomers comprise decamethylene diamine and pentamethylene diamine, and a molar ratio of the decamethylene diamine to the pentamethylene diamine is in a range of 1:1 to 30:1.
